(19) United States
(12) Patent Application Publication
(10) Pub. No.: US 2023/0049768 A1
(43) Pub. Date: Feb. 16, 2023

(54) A METHOD FOR SYMMETRIC ASYNCHRONOUS GENERATIVE ENCRYPTION

(71) Applicant: ZEU TECHNOLOGIES, INC., Montreal (CA)

(72) Inventors: Jean-Philippe BEAUDET, Montreal (CA); Francois DUMAS, Montreal (CA)

(73) Assignee: ZEU TECHNOLOGIES, INC., Montreal, QC (CA)

(21) Appl. No.: 17/791,510

(22) PCT Filed: Jan. 11, 2021
(86) PCT No.: PCT/CA2021/050018

§ 371 Date: Jul. 7, 2022

Related U.S. Application Data
(60) Provisional application No. 62/959,572, filed on Jan. 10, 2020.

(51) Int. Cl. H04L 9/08; H04L 9/06

(52) U.S. Cl. CPC H04L 9/0825; H04L 9/0643; H04L 9/0869

(57) ABSTRACT

Methods of data encryption using a mutating encryption key are disclosed. The methods generate an encryption key and utilize a codex to mutate or vary the encryption key value. The encryption key may be generated using a random number generator. The encryption key value in pre-mutation state, together with the codex, is used to generate the next valid value for the encryption key. Unencrypted message data may be used together with the codex to mutate the encryption key. A valid encryption key and the unencrypted or successfully deciphered message are thus required to mutate the encryption key to the next key post-mutation state at each end.

### TECHNICAL FIELD

The present disclosure relates generally to the field of cryptography, in the family of symmetric encryption, in a new family of generative encryption and more specifically to a

Method for Symmetric Asynchronous Generative Encryption.

### BACKGROUND

Historically, asymmetric encryption relies on the strong concept of resolving an elliptic curve mathematical challenge and/or prime numbers, which is extremely difficult.

The concept of utilizing elliptic curves was proposed for use in cryptography in 1985 by Neal Koblitz from the University of Washington, and separately by Victor Miller at IBM (see https://searchsecurity.techtarget.com/definition/elliptical-curve-cryptography). Elliptical curve cryptography (ECC) is a public key encryption technique based on elliptic curve theory that can be used to create faster, smaller, and more efficient cryptographic keys. ECC generates keys through the properties of the elliptic curve equation instead of the traditional method of generation as the product of very large prime numbers.

The industry still has some reservations about the use of elliptic curves. Nigel Smart, a Hewlett Packard researcher, discovered a flaw in which certain curves are incredibly vulnerable. However, Philip Deck of Certicom says that, while there are curves that are vulnerable, those implementing ECC would have to know which curves could not be used. He believes that ECC offers a unique potential as a technology that could be implemented worldwide and across all devices. According to Deck, who was quoted in Wired Magazine, “the only way you can achieve that [i.e., interoperable encryption system across all computing devices] is with elliptic curve”.

Whether using ECC or pure prime number RSA (Rivest-Shamir-Adleman), the challenge relies on the sheer difficulty to resolve a challenge to gain the ability to understand a secret, i.e., a private key.

Currently, in the classical computing paradigm, breaking these challenges is nearly impossible and would require enormous computing power and at least a hundred years or so to accomplish.

In the last years, the emergence of quantum computing science has fundamentally changed established concepts such as Moore's Law, which states that computing power doubles in capacity about every two (2) years. Quantum computing power however is increasing exponentially. Although there are still some serious limitations to the general usage of these computers, it can be expected that within a limited period of 5-10 years, quantum computers could be employed to break classical encryptions in minutes or even seconds. The flaw being that mathematical equations or challenges, as hard as they can be, will eventually be computed by a more powerful algorithm.

Another flaw would be that pattern recognition algorithms can, in certain circumstances, operate and identify repetition according to natural language recognition. Using such a method enables a malicious actor to decipher a certain number of symbols, thus enabling them to reverse engineer the contents of an encrypted message without breaking the actual key. It is important to note that this is not only very difficult but time and cost-intensive as well.

A final difficulty would be that current asymmetric encryption generally relies on the re-use of specific key pairs either in the form of 2-way encryption or as a ROOT certificate authority. This creates a situation in which state, non-state, and malicious actors record potentially sensitive information, such as government database, financial information, medical information, and military information, with the thought of using ulterior means to decipher them in the future in the hope they will still be relevant, which will likely be the case. The identity and medical information in most government databases are persistent and could still be relevant in the coming decade.

### SUMMARY

This disclosure aims at mitigating the flaws identified in the prior art by removing the mathematical equation, thus enforcing brute-force-only cracking possibilities; enabling key mutability on each encryption/decryption, which limits the windows of opportunity for key breaking operations considerably; and expanding the probabilistic threshold of guessing the encryption secret to ridiculous, near-infinite numbers.

In accordance with one aspect of the present invention, there is provided a method of generating an index and a codex made of a base of N binary digits, the index being an ordered list of all combinations used as a reference for generation of a codex, wherein the codex comprises a random list of all combinations created using an encryption key; and the codex is unique and created between a set of two or more users for establishing a communication channel.

In accordance with another aspect of the present invention, N may be 8, 16, 32, and 64.

In accordance with another aspect of the present invention, there is provided a method of generating a symmetric encryption key for handshake between a first user and a second user. The method includes: at a random number generator (RNG): receiving, at the RNG, requests of digits from the first and second users; generating a first and second list of numbers at the RNG; parsing the first and second lists using a reference table containing symbols associated with the numbers; and sending a first and second symbol lists to the first and second users respectively; wherein the lists are combined to create a new unique key to be sent as a channel creation request or acceptance.

In accordance with yet another aspect of the present invention, there is provided A method of encryption of data, using a mutating encryption key and a codex, the method comprising: creating an offset using a value of the encryption key in pre-mutation state; keeping a temporary record of the first N bytes of pre-encrypted data as an entropy list; encrypting the data; mutating the encryption key value using the first N bytes to create the mutated key value for a post-mutation state for the encryption key; and saving the mutated key value as the current encryption key.

### BRIEF DESCRIPTION OF THE DRAWINGS

In the accompanying drawings, which illustrate one or more embodiments:

FIG. 1 is a flow diagram depicting an index generation process, exemplary of an embodiment of the present invention;

FIG. 2 is schematic block diagram illustrating an exemplary encryption key generation process;

FIG. 3 is a schematic block diagram illustrating an exemplary codex generation process;

FIG. 4 is a schematic block diagram illustrating an exemplary key mutation process;

FIG. 5 is a schematic block diagram illustrating an exemplary encryption process; and

FIG. 6 is a schematic block diagram illustrating an exemplary deciphering process.

### DETAILED DESCRIPTION OF THE EMBODIMENTS

Directional terms such as “top,” “bottom,” “upwards,” “downwards,” “left,” “right,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one; for example, the term “plurality includes two or more, three or more, four or more, or the like.

In this disclosure, the terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

A codex is a database with layers containing all combinations of (encoding*bits) in a random order assigned using the genesis and the initiator key. The codex is composed of a minimum of two (2) and a maximum of 256 layers.

Encoding the base number of binary digits that are used for encryption and decryption. The index and codex layers are composed of (2**encoding) combinations of encoding*bits.

Entropy is the concept of signal, in the form of integers, that is used to mutate the current key symbol into a new set of key symbols. The integers used for this are taken from a list of incoming or outgoing bytes. Thus, only with a valid key and successfully deciphered message can mutate the key to the next key valid state.

Genesis key is a 2-48 symbol key that is used only once at the codex creation.

Initiator key is used both at codex creation and as the initial valid key state.

A key symbol is a symbol chosen from a list of 90 characters, majuscule letters, minuscule letters, numbers, and special characters. All symbols are associated with a value between 0-89.

A key state is the current set of 2048 symbols representing the current key “state.”

A layer is composed of a unique distribution of all combinations of (encoding*bits). No layer should ever be the same (almost impossible collision).

A valid key state is when a current set of 2048 symbols are synchronized and can either encrypt or decrypt a new message. The valid key state is confirmed by the presence of a checksum enabling a receiver to confirm the successful decryption of a message without revealing the message or any part of its contents.

Symmetric Asynchronous Generative Encryption (SAGE) relies on the asynchronous synchronization of mutable encryption keys to communicate. The algorithm uses three (3) main elements: random number generation (RNG), a codex, and an encryption key.

The random number generation (RNG) could be achieved through multiple methods. One exemplary method is the applicant's methods described in a patent application published as WO/2020/146955 entitled “A Method for Generating Random Numbers in Blockchain Smart Contracts”, which uses a patent-pending blockchain-based random number generator to generate the random seed. Each participant provides a seed to the smart contract, and the smart contract generates a new random number based on the seed provided by each participant and the block info.

The codex is a common reference table of randomly assigned binary combination distribution created by both end users once they create a communication channel. Each codex has a minimum of two (2) layers and a maximum of two hundred fifty six (256); each layer is the complete random distribution of all possible binary permutation of n bits. Depending on the base encoding used, a layer length is 2**n bit (256:8 bit, 65536:16 bit, 4294967296:32 bit, etc.). Therefore, the base probability of brute force would be 2**(2**base encoding).

The encryption keys are generated using any RNG method to generate 2048 symbols with a value between 0-89. The base probability of brute force would be approximately 90**2048.

The codex is generated from the combined use of a genesis key, which is unique and used once, and an initiator key, which is to be used at the first communication. These keys are generated using the combination of exchanged set of 2048 symbols between two end users, referred to hereafter as the handshake. Both end users are now sharing 4096 symbols. The handshake is then broken down into two (2) combined sets of 2048 symbols, each set derived from half of each end user, the genesis key, and the initiator key. The handshake serves as a request for communication, and its acceptance is resolved by the receiver responding with its handshake of 2048 symbols.

The codex is used to map incoming and outgoing bytes. Encryption keys are used to generate a random, mutable, offset to the real positioning of the bytes mapping referred here as the shuffling of the codex. To visualize the process, one could imagine that each digit of the key offsets the position of each byte of the payload, much like a roulette turning right and then left on a modulo bytes reference table. It could also be considered similar to the number synchronization technology used by banks. The base probability of guessing a new valid state from the last would be approximately 10**2048.

Then, each time a payload is encrypted of deciphered, the incoming bytes serve as a reference for key mutation, thus changing the key upon usage. The only way for an end user to remain in the loop is to successfully decipher incoming bytes, thus mutating the key to the same valid state as the sender.

Synchronization of both end users keys is done asynchronously on each end user's side and happens extremely fast, such as in the case of packet streaming, e.g., multiple times per second. It is important to note that synchronization must be achieved each time, or the ability to decipher is lost. This can have advantages such as including and excluding end users from a communication channel.

Any number of codex can be created in parallel. Any number of end users can use the same codex. Any number of end users can use the same initiator key, but none will have the same key state unless they all are reading the same message threads.

As for performance, the codex is generated in a local end user database from a deterministic protocol derived from the genesis key. The process of mapping and retrieval of bytes is done in parallel by available CPU cores. Encrypted messages are compressed.

Index Generation:

The index is a utility built for performance purposes, which accelerates the codex creation. The index is a reference table of orderly binary combinations of n bits (i.e., 8, 16, 32, 64). The index has one (1) layer and has a length of (2**base encoding). The index is used by the codex generator in a random way to be shuffled into a unique codex.

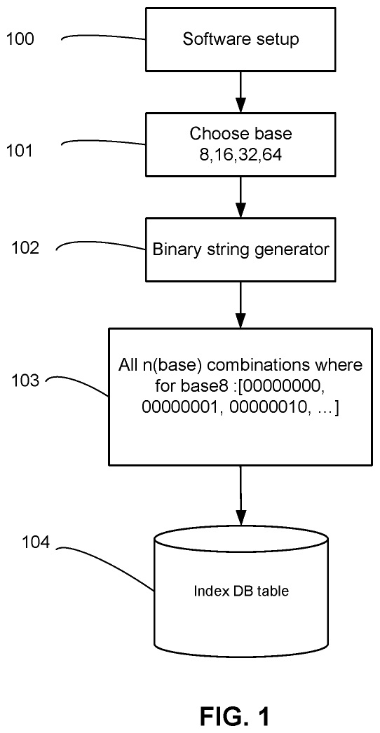

Referring to FIG. 1, at 100 software setup is launched at installation and will setup the index and codex database (db) table, install dependencies, and expose the micro-services for codex generation, key generation and encoding/decoding.

At 101, the index generation is launched for the chosen base encoding. The user chooses one or more options, between: 8-bit encoding (index length=256); 16-bit encoding (index length=65,536); 32-bit encoding (index length=4,294,967,296); and 64-bits encoding (index length=18,446,744,073,709,551,615).

At 102, the binary string generator is used to create all possible variations of the chosen n bits.

At 103, the binary string generator returns a list of all possible variations in bytes string format.

At 104, the index is saved in the index_base(n) table. An exemplary table schema may look as follows:

base(n): {
position(int) : bytes string(string),
position(int) : bytes string(string),
position(int) : bytes string(string),
etc.
}

Encryption Key Generation

Encryption key generation is made in a semi-deterministic pattern precluding that both users provide randomness from their side. The end user has the choice of randomness or pseudo-randomness source, but random number generation (RNG) technology is strongly advised.

Key generation is a vital process from which the randomness is included in the creation of a communication channel for end users. Communication channels are the combination of a unique codex and an initial encryption key, referred to here as the initiator key.

The uniqueness of the codex is created from the combined use of two (2) keys, the genesis key and the initiator key.

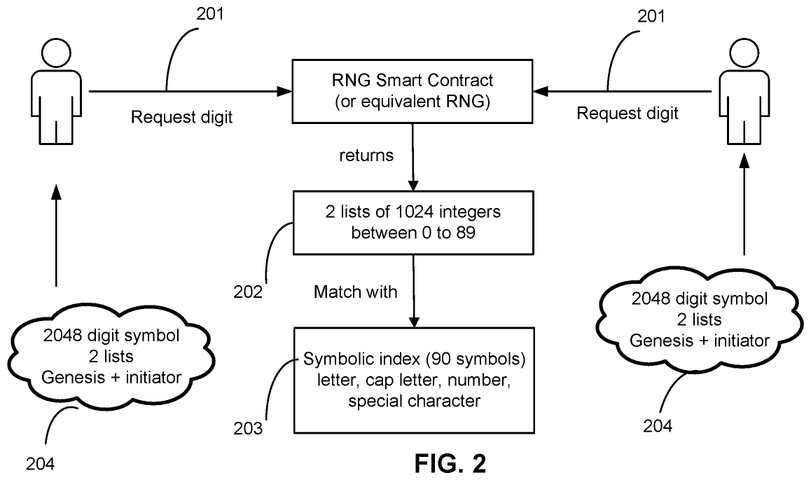

Now with reference to FIG. 2, at 201, upon a new key creation request, the end users, either simultaneously or otherwise, request digits from the RNG source. In this example, the aforementioned method described in a patent application published as WO/2020/146955 entitled “A Method for Generating Random Numbers in Blockchain Smart Contracts” is used. Both end users send digit requests to the RNG smart contract.

At 202, the smart contract returns two (2) lists of 1024 integers of value between 0-89.

At 203, the two (2) lists of numbers are parsed using a reference table containing the symbol associated value. These values are essential and are used by the encryption key during codex generation, encoding, and decoding.

At 204, the two (2) lists of 1024 symbols are returned to the end users. They can be combined to create a whole new unique key and are sent as a channel creation request or acceptance.

By default, the two (2) half-keys correspond to the genesis and initiator key needed during the handshake process.

Codex Generation

The codex is a unique set of randomly assigned positions for all n bits combinations in string format on multiple layers. Each layer is a complete variation set of its own and is a different random order than any other layer of a specific codex. The chance of having the same codex value twice is very low and depends on the base encoding. It is roughly: (layer**(2**base encoding)).

The codex is saved into its own db table codex_base(n). It serves as a reference table to assign positions to bytes strings. It is used to map incoming or outgoing bytes into coded positions. By referring to the byte position and length, it can be mapped and retrieved without loss.

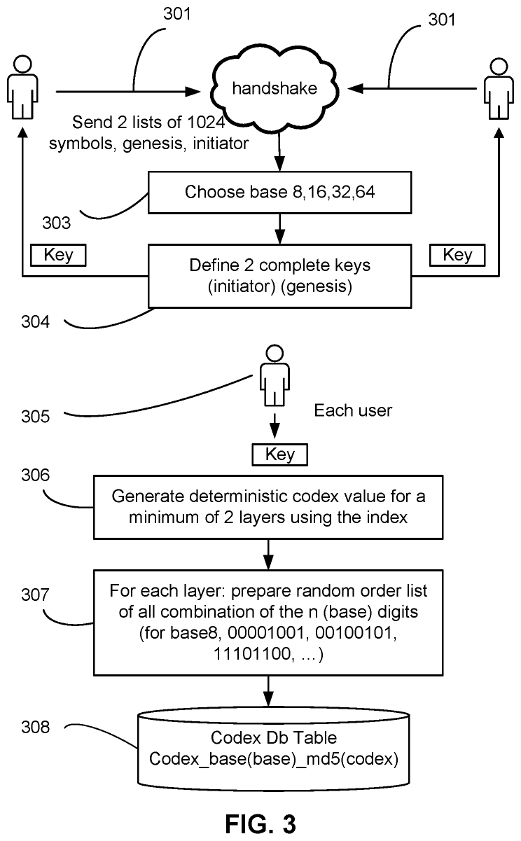

Referring to FIG. 3,

301: The codex generation can also be described as a communication channel creation. It is initiated through a process of request and acceptance referred to here as the handshake.

In this case, two (2) end users initiate a handshake process. It is important to note that more than two (2) end users can participate in the creation of a common codex.

302: The first end user receives the handshake request in the form of two (2) lists of 1024 symbols each. To accept this handshake request, the end user returns two (2) lists of 1024 symbols as well.

303: End user request and acceptance are also comprised of a value indicating the base encoding to be used for codex generation.

304: Once the request has been accepted, both end users end up with four (4) lists of 1024 symbols. From this, both users combine them into two (2) keys, the genesis key and the initiator key. The requesting end user is used as the first position by default, although this can be overridden by indicating an optional value at the handshake.

305: The end users now have two (2) keys of 2048 symbols each:

The genesis key (unique and used only once at codex generation)

The initiator key (used at the initial key state when starting communication)

306: Each end user now initiates on their client-side the codex generation using a deterministic approach derived from the combination of the genesis key and the initiator key.

307: Each layer of the codex is composed of (2**base encoding) value of (base encoding*bits). No layer is the same order as any previous layer, and they have a minimum number of 2 and a maximum number of 256.

The rough probability of Guessing one codex layer is: (2**base encoding), for the full codex: (layers**(2**base encoding))

308: The codex is saved to the codex_base(n)[layer] table. The schema would look like this:

codex_base(n)[layer] :
{
position(int): bytes string (string),
position(int): bytes string (string),
position(int): bytes string (string),
etc.
}

### Key Mutation

Key mutation is a core concept of the protocol. It works with the logic of asynchronous key synchronization using a successful communication loop and a unique common reference table (the codex). The key mutation is achieved by the usage of encoding and decoding methods. The mutation is initiated by the processed bytes, and optionally, a common secret reference exchanged during the handshake.

Optionally, a checksum of unencrypted bytes can be sent between end users to confirm successful decryption; thus, validating the new key state.

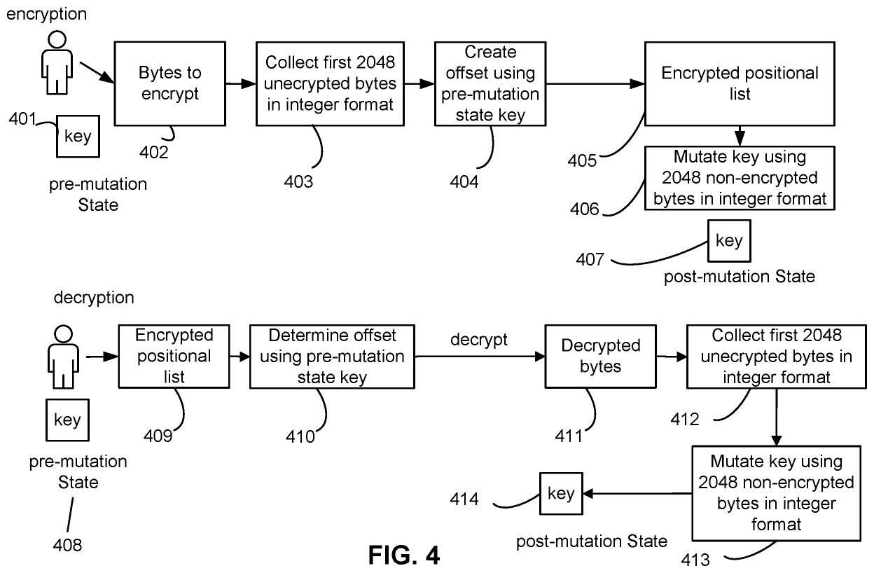

Referring now to FIG. 4.

401: The end user prepares to encode a message to be sent to another end user. The initiator key is now at a pre-mutation state, meaning that the key state has not changed yet.

402: The end user processes bytes as usual (see Encryption).

403: The end user keeps a temporary record of a maximum of the 2048 first bytes from the current encoded message. This would be referred to as the entropy.

404: The current pre-mutation key state is used to create the offset to the current position mapped as usual (see Encryption).

405: Encryption occurs, and the positions are mapped and offset.

406: Key mutation occurs using the pre-encrypted bytes list. Each byte modifies all symbol values using a modulo(90) starting at the current symbol value.

407: The key is saved as a new valid key state.

408: The receiving end user starts with the initiator (pre-mutation) key state.

409: The end user processes the encoded positional mapping as usual (see Deciphering)

410: The end user determines the current valid offset using the initiator key.

411: The decoding occurs, and the receiving end user is now able to read the unencrypted bytes.

412: The end user collects up to 2048 first bytes as their entropy.

413: The receiving end user is now able to mutate their key to the new valid state.

414: The new valid key state is saved. The end user can now either send a new message or wait for a new incoming one.

### Encryption

Encryption (or encoding) is done by the usage of a unique common reference table, the codex. The codex maps out randomly assigned bytes string to numerical position values. By recording the position and byte length, the bytes can be retrieved at no loss.

Optionally, every time data is encoded, a checksum of unencrypted data is kept and sent for confirmation of successful decryption.

The encoding can be done either on a unique file or a buffer. In either case, the method returns an encoded positional map or the requested bytes list. In the case of a file, the file is saved at the end of the operation. In the case of a buffer, the encoded bytes are left as-is to be concatenated later by the codebase.

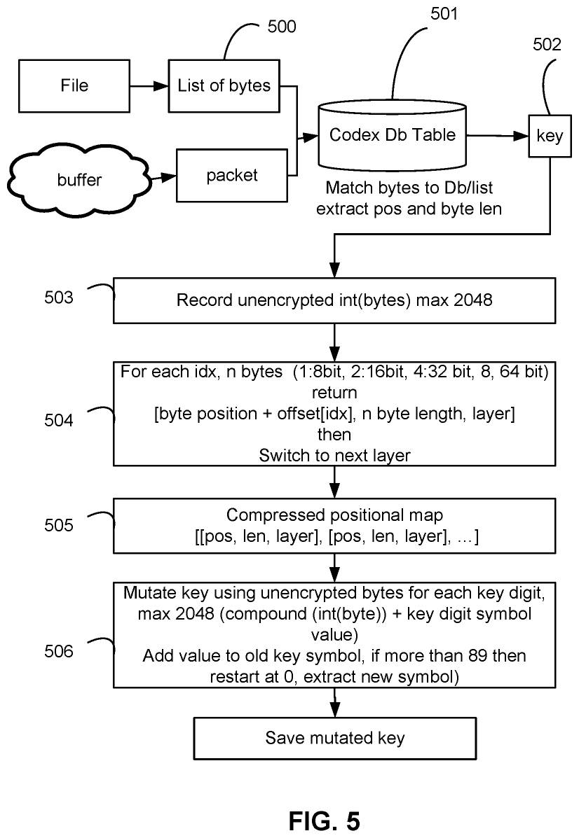

Referring to FIG. 5, the encoding will either be run on a file or a buffer bytes packet.

501: Each byte or combination of bytes is processed. (8:1 bytes, 16:2 bytes, 32:4 bytes, 64:8 bytes) and mapped using the first occurring instance of it in order of appearance at the current layer.

Ex:

Base 16: incoming 2 bytes: 00100011 10100110

Each db table entry has 16 bits.

The first byte (00100011) is searched from (n) db item at position [0: bytes length]

The second byte is searched from (the same n) db item at position [8: bytes length+8]

The first entry that matches all conditions in the same position is recorded as the valid position for mapping and is appended to the list along with byte length and layer.

502: Each time a position is defined, the current valid key state is used to offset the recorded position using the key symbol as an integer list modulo. It iterates on the key modulo for each position and uses the integer value as the offset value switching from right(+) to left(−), much like a series of roulettes.

503: The current entropy state (unencrypted bytes to integer) is recorded in a list.

504: The offsets are applied to the positions.

505: The encoded file is saved, or the encoded packet is returned.

506: The current valid key state is mutated using the entropy list. Each entropy digit modifies the full key value, the knowledge of all entropy related bytes in the correct order, and optionally the common secret reference exchanged at the handshake, all of which is needed to define the new valid key state.

507: The new valid key state is saved.

### Deciphering

Deciphering or decoding is done by the usage of a unique common reference table, the codex, and the current valid key state. The codex enables the mapping out of the corresponding bytes to a series of positions, byte lengths, and layer references.

Optionally, a checksum of unencrypted bytes is sent with the encrypted message; thus, the end user can confirm that they successfully decrypted the message and is at the valid key state.

Decoding can be done either from a fully encoded file or an encoded stream from a buffer. It returns the unencrypted file of the unencrypted buffer packet. In the case of a buffer, the bytes are left to be concatenated by the codebase.

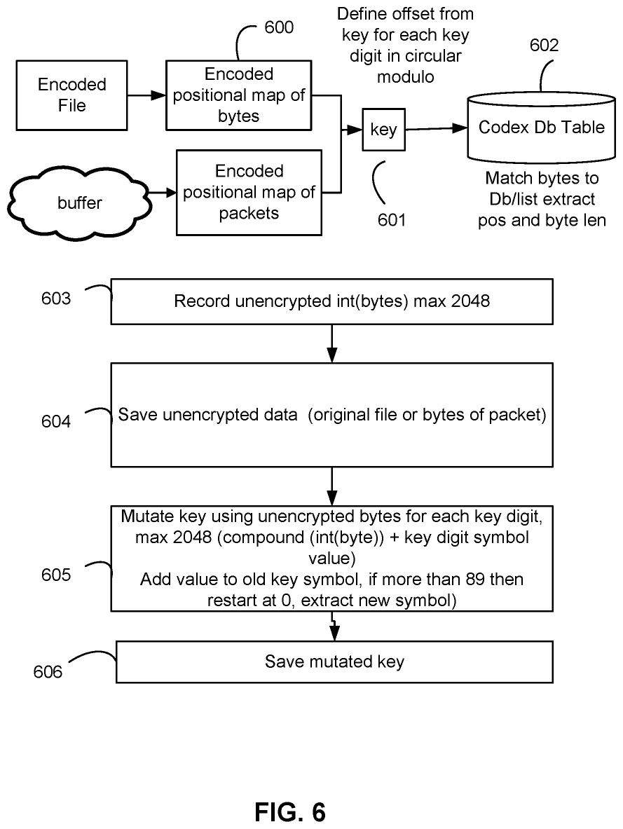

Referring to FIG. 6,

600: The end user extracts the encoded positions from the encoded file or buffer packet.

601: The end user determines the offset list from the current valid key state.

602: The end user matches the position and layer to a bytes string. From the bytes string, each byte is extracted using the byte length and its order.

Ex:

Base 32: incoming bytes set: 00011111 01010101 01110000 00111100

Each db entry has 32 bits.

The offset is applied to the position list to extract a valid position.

The bytes string corresponding to a valid position is extracted.

The first byte is extracted from position [0:byte length].

The second is extracted from position [8:byte length+8].

The third is extracted from position [16:byte length+16].

The fourth is extracted from position [24:byte length+24].

Bytes are appended to the final bytes return list.

603: Up to the first 2048 decoded byte integer values are recorded to the entropy list for key mutation.

604: The unencrypted bytes are saved to a file, or the unencrypted bytes packet is returned.

605: The current key valid state mutates using the entropy list.

606: The new valid key state is saved.

### Protocol—Channel Setup (Alice and Bob)

Channel Setup Step 1—Handshake Request

Alice wishes to initiate a communication channel with Bob.

Alice generates her genesis and initiator half-key.

Alice sends Bob a communication channel request in the form of submitting the two (2) half keys and possibly forwarding optional value such as a common secret reference of any sort.

Channel Setup Step 2—Handshake Acceptance

Bob receives Alice's request.

Bob generates his genesis and initiator half-keys.

Bob sends Alice his acceptance in the form of the two (2) half keys and possibly forwarding optional values.

Alice receives Bob half-keys.

The handshake is considered successful.

Channel Setup Step 3—Codex Generation

Alice and Bob both generate a common codex derived from the combination of the genesis and the initiator keys.

Alice and Bob now have a codex and the initiator key, the genesis key is used only once and discarded at this stage.

The communication channel is now considered valid and can be used to send and receive messages.

### Protocol—Channel Messaging (Alice and Bob)

Message Channel Step 1—Alice Encodes Message

Alice encodes the message using the common codex assigned to the current communication channel and Alice's current valid key state.

Message Channel Step 2—Alice Key Mutates

Alice mutates the key state using the entropy extracted from outgoing bytes.

Alice now has Alice's new key state.

Message Channel Step 3—Alice Sends Message (file or buffer)

Alice sends the message to Bob in the form of a compressed encoded positional map.

Message Channel Step 4—Bob Receives Message

Bob receives Alice's message in the form of a compressed positional map.

Message Channel Step 5—Bob Decodes Message

Bob decodes the message using the common codex for this channel and Bob's current valid key state.

Bob extracts the entropy from the successfully deciphered bytes.

Message Channel Step 6—Bob Key Mutates

Bob mutates the current valid key state using entropy.

Bob now has a new valid key state corresponding to Alice's new valid key state.

List of Methods:

ConvertToInt(key_list):

Convert key symbols into corresponding integers.

Decrypt(cipher_message, key, encoding, codex):

A function to decrypt an encoded message using a unique codex and the valid key state. It also mutates the key and returns a checksum to validate successful decryption (to be returned to the sender as a confirmation receipt).

Encrypt(message, key, encoding, codex):

A function to encrypt a message using a cipher derived from a unique codex and the valid key state. It also mutates the key and returns a checksum to validate successful decryption.

GenerateAllBinaryString(e=encoding):

Generation all combinations of (encoding*bits).

Ex: 8bits generates 256 combinations of 8bits.

GenerateCodex(g=genesis key, i=initiator key, e=encoding, num=number of layer):

Generate a unique codex with num layers of (2**e) length using the genesis and initiator keys. Each layer is unique, and the probability of guessing all layers in the right order would be (num**(2**e)).

GenerateKey(seed):

Generate a key from a seed of 2048 integers between 0-89.

GenerateLayer(g=genesis key, i—initiator key, e=encoding):

Generate a layer of combination with all combinations of (e*bits). Each layer has a unique order. The layer is picked using the genesis and initiator keys. Each entry is picked up at key1[for char in char]*key2[for char in char] in the index corresponding to e.

MutateKey(key, entropy):

Mutate key state using entropy. Entropy is taken from incoming and outgoing bytes.

```
    SymbolIndex{object= all symbol value between 0-89}
    Index Generation
    generate_index(e=encoding):
      if encoding in [8, 16, 32, 64]:
        index = GenerateAllBinaryString(e)
      return index
    Codex Generation
    GenerateCodex(genesis, initiator, encoding, num_layer):
    codex = new codex Db (encoding, num_layer)
      for n in num:
        layer, last_used = GenerateLayer(g, i, e, last_used)
        codex push (layer)
      return hash(codex)
    GenerateLayer(g= genesis, i =initiator, e= encoding, last_used):
      idx = list(index) #instance of a full codex layer extracted from the index
    done = 0
    total = (2**e)
    layer =[ ]
      for n in total:
        val = SymbolIndex[modulo(2048) g[n]] *
SymbolIndex[modulo(2048) i[n]]
        next =modulo(total − done) idx[val]
        layer.append(next)
    pop idx[val]
    done ++
    return layer, last_used
    Key Generation
    GenerateKey(seed):
    key = [ ]
      for number in seed:
        symbol = SymbolIndex[number]
        key.append(symbol)
      return “”.join(key)
    Key Mutation
    ConvertToInt(key_list):
      int_list =[ ]
      for symbol in key_list:
        int = SymbolIndex[indexOf(symbol)]
        int_list.append(int)
      return int_list
    MutateKey(key, entropy):
      keyList =[ ]
      int_list = ConvertToInt(list(key))
      for signal in entropy:
        newSymbol = modulo(90) entropy + int_list[signal]
        keyList.append(newSymbol)
      newKey = “”.join(keyList)
      checksum = hash(newKey)
      return newKey, checksum
    Encryption
    encrypt(message, key, encoding, codex):
      cipher_message = [ ]
    entropy = [ ]
      for index, bytes in enumerate(message):
        entropy.append(bytes)
        # comments: iterate on codex Db layers each time
        position = find bytes in codex Db[for layer in layer]
    # comments: number of byte length in array = (encoding/8) ))
    offset = position + SymbolIndex[indexOf( key[index])]
        cipher_message.extend([offset,[ length(bytes),], layer])
      mutated_key, checksum = MutateKey(key, entropy)
      return cipher_message, mutated_key, checksum
    Decryption
    decrypt(cipher_message, key, encoding, codex):
      plain_message =[ ]
      entropy =[ ]
      group = 2+ (encoding /8)
    next = 1
    current =[ ]
      for index, number in enumerate(cipher_message):
        if next < group:
          current.append(number)
    next ++
        else:
          position = current[0] − SymbolIndex[indexOf( modulo2048
key[index])]
          byte = find (position) in codex Db[for layer in layer]
    if encoding is 8:
            b[0] = byte[0:current[1]]
    if encoding =is16:
    b[1] = byte[8:current[1]+8]
          if encoding is 32:
            b[2] = byte[16:current[1]+16]
    b[3] = byte[24:current[1]+24]
          if encoding is 64:
            b[4] = byte[32:current[1]+32]
    b[5] = byte[40:current[1]+40]
            b[6] = byte[48:current[1]+48]
    b[7] = byte[56:current[1]+56]
    #finally
    current = [ ]
    plain_message.extend(b)
    for i in b:
      entropy.append(int(i))
    mutated_key, checksum = MutateKey(key, entropy)
      return plain_message, mutated key, checksum
    Written proof
    Let codexBase8_47b78f7505a0f8d135c9b76bb917fff2
    {“codex”: [
    #layer 1
    [“00101000”, “11000011”, “11111001”, “11101010”, “10100010”, “11110001”,
“11010101”, “00100000”, “00101010”, “11000111”, “01100010”, “11110010”, “10100110”,
“11111010”, “11011011”, “00100001”, “00101100”, “11001100”, “01100101”, “11111011”,
“10101010”, “00001010”, “11100010”, “00100011”, “00101111”, “11010010”, “01101001”,
“10110000”, “10101111”, “00001011”, “11101011”, “00100101”, “00110010”, “11011010”,
“01101101”, “10110110”, “10110101”, “00001100”, “11110101”, “00100111”, “00110101”,
“11100011”, “01110001”, “10111100”, “10111011”, “00001101”, “00111100”, “00101011”,
“00111000”, “11101101”, “01110110”, “11000100”, “11000010”, “00001110”, “01000000”,
“00101110”, “00111011”, “11111000”, “01111011”, “11001101”, “11001011”, “00001111”,
“01000100”, “00110001”, “00111111”, “11101000”, “10000000”, “11010110”, “11010100”,
“00010000”, “01001000”, “00110100”, “01000011”, “11110110”, “10000101”, “11011111”,
“11011110”, “00010001”, “01001100”, “00110111”, “01000111”, “11001110”, “10001010”,
“11101100”, “11101001”, “00010010”, “01010000”, “00111010”, “01001011”, “11011000”,
“10001111”, “11111101”, “11111100”, “00010011”, “01010100”, “00111110”, “01001111”,
“11100100”, “10010100”, “10111001”, “00111101”, “00010100”, “01011001”, “01000101”,
“01010101”, “11110100”, “10011010”, “11000101”, “01000010”, “00010101”, “01011110”,
“01001010”, “01011010”, “01111010”, “10100001”, “11010011”, “01001001”, “00010110”,
“01100100”, “01010001”, “01011111”, “10000010”, “10101011”, “11100110”, “01001110”,
“00010111”, “01101011”, “01010110”, “01100110”, “10001100”, “11101110”, “11000110”,
“01011000”, “11010111”, “10100011”, “01010111”, “01101010”, “10010001”, “10111110”,
“11011001”, “01011100”, “11101111”, “10101001”, “01011011”, “01101111”, “10010110”,
“11001010”, “11110000”, “01100000”, “00011000”, “10110011”, “01100001”, “01110100”,
“10011100”, “11100001”, “01101000”, “01100111”, “00011001”, “11000000”, “01101100”,
“01111100”, “10100101”, “10001011”, “01110010”, “01110000”, “00011010”, “11011101”,
“01110011”, “10000011”, “10110010”, “10010101”, “01111000”, “01110111”, “00011011”,
“10010010”, “01111001”, “10001001”, “11001000”, “10011111”, “01111111”, “01111110”,
“00011100”, “10011101”, “10000001”, “10010111”, “11100111”, “10101110”, “10000111”,
“10000110”, “00011101”, “10101100”, “10001000”, “10100000”, “00000010”, “11011100”,
“10100111”, “10010000”, “10111010”, “00110110”, “10010011”, “10110100”, “00000011”,
“10011000”, “10111101”, “10011110”, “11100000”, “01000001”, “10100100”, “11001111”,
“00000100”, “10101000”, “11100101”, “10110111”, “00100100”, “01010010”, “10111111”,
“00000000”, “00000110”, “11001001”, “11110111”, “11110011”, “00101101”, “01101110”,
“11111111”, “00100110”, “00000111”, “10101101”, “00110000”, “00000101”, “01100011”,
“10011001”, “00000001”, “01000110”, “00011110”, “11000001”, “01010011”, “00001001”,
“10011011”, “10110001”, “00001000”, “01111101”, “00101001”, “10000100”, “10001110”,
“00100010”, “11111110”, “00111001”, “00011111”, “00110011”, “01110101”, “10001101”,
“01001101”, “10111000”, “11010000”, “01011101”, “11010001”],
    #layer2
    [“00111101”, “10110011”, “00101010”, “10001001”, “11011100”, “00010101”,
“11010111”, “11010011”, “01000000”, “10111000”, “00101100”, “10001101”, “11100100”,
“00010110”, “11011111”, “11011010”, “01000011”, “10111101”, “00101110”, “10010001”,
“11101100”, “00010111”, “11100111”, “11100010”, “01000110”, “11000010”, “00110000”,
“10010101”, “11110100”, “00011000”, “11101111”, “11101010”, “01001001”, “11000111”,
“00110010”, “10011001”, “11111100”, “00011001”, “11110111”, “11110010”, “01001100”,
“11001100”, “00110100”, “10011101”, “01010110”, “00011010”, “00111001”, “11111101”,
“01010000”, “11010100”, “00110110”, “10100011”, “01011011”, “00011011”, “00111100”,
“01101010”, “01010100”, “11100000”, “00111000”, “10101010”, “01100000”, “00011100”,
“01000001”, “01110000”, “01011001”, “11101101”, “00111011”, “10110001”, “01100101”,
“00011101”, “01000101”, “01110110”, “01011110”, “11111001”, “00111111”, “10111010”,
“01101011”, “00011110”, “01001010”, “01111100”, “01100011”, “00001100”, “01000111”,
“11000100”, “01110010”, “00100000”, “01001111”, “10000011”, “01101001”, “00001101”,
“01001101”, “11001110”, “01111001”, “00100010”, “01010101”, “10001011”, “01110001”,
“00001110”, “01010010”, “11011001”, “10000000”, “00100100”, “01011100”, “10010100”,
“01111000”, “00001111”, “01011000”, “11101000”, “10000111”, “00100110”, “01100010”,
“10011110”, “01111111”, “00010000”, “01011111”, “11110110”, “10010000”, “00101000”,
“01101000”, “10100110”, “10000110”, “00010001”, “01100110”, “00110011”, “10011011”,
“00101011”, “01110011”, “10101111”, “10010010”, “01111101”, “01101101”, “00000111”,
“11000000”, “00101111”, “10111001”, “10110100”, “10011010”, “10000100”, “01110100”,
“00001000”, “11001011”, “00110101”, “11000101”, “10111110”, “10100010”, “10001100”,
“01111010”, “00001001”, “11011000”, “00111010”, “11010000”, “11001001”, “10101001”,
“10010110”, “10000001”, “00001010”, “11101001”, “01000010”, “11011110”, “11010101”,
“10110000”, “10011111”, “10001000”, “00001011”, “11111010”, “01001000”, “11110000”,
“11100101”, “10111011”, “10100101”, “10001111”, “00010010”, “11010110”, “01001110”,
“10100001”, “11111011”, “11001000”, “10101101”, “10011000”, “00010011”, “11101110”,
“01010011”, “10101011”, “11110011”, “11011011”, “10110111”, “10100100”, “00010100”,
“00100001”, “01011101”, “10110110”, “11010001”, “11111000”, “11001010”, “10101110”,
“00011111”, “01101110”, “01100100”, “01010111”, “00111110”, “10000101”, “11101011”,
“11000110”, “00100011”, “01111110”, “01110101”, “01100111”, “01001011”, “10100000”,
“00110111”, “11110001”, “00100101”, “10011100”, “10001110”, “01111011”, “01100001”,
“10111111”, “01010001”, “00000110”, “00101001”, “11000001”, “10110010”, “10100111”,
“10000010”, “11110101”, “10101100”, “01011010”, “00101101”, “11100011”, “11010010”,
“11000011”, “10010111”, “00000101”, “11011101”, “01110111”, “01000100”, “00100111”,
“11100110”, “11001101”, “11100001”, “11001111”, “00000010”, “10110101”, “10001010”,
“10101000”, “01101100”, “00000011”, “00000001”, “10111100”, “00110001”, “01101111”,
“00000100”, “00000000”, “11111110”, “10010011”, “11111111”]]}
    let index =
        self.index = {
          “1” : 1,
          “2” : 2,
          “3” : 3,
          “4” : 4,
          “5” : 5,
          “6” : 6,
          “7” : 7,
          “8” : 8,
          “9” : 9,
          “0” : 10,
          “a” : 11,
          “b” : 12,
          “c” : 13,
          “d” : 14,
          “e” : 15,
          “f” : 16,
          “g” : 17,
          “h” : 18,
          “i” : 19,
          “j” : 20,
          “k” : 21,
          “l” : 22,
          “m” : 23,
          “n” : 24,
          “o” : 25,
          “p” : 26,
          “q” : 27,
          “r” : 28,
          “s” : 29,
          “t” : 30,
          “u” : 31,
          “v” : 32,
          “w” : 33,
          “x” : 34,
          “y” : 35,
          “z” : 36,
          “!” : 37,
          “@” : 38,
          “#” : 39,
          “$” : 40,
          “%” : 41,
          “?” : 42,
          “&” : 43,
          “*” : 44,
          “(” : 45,
          “)” : 46,
          “-” : 47,
          “=” : 48,
          “+” : 49,
          “A” : 50,
          “B” : 51,
          “C” : 52,
          “D” : 53,
          “E” : 54,
          “F” : 55,
          “G” : 56,
          “H” : 57,
          “I” : 58,
          “J” : 59,
          “K” : 60,
          “L” : 61,
          “M” : 62,
          “N” : 63,
          “O” : 64,
          “P” : 65,
          “Q” : 66,
          “R” : 67,
          “S” : 68,
          “T” : 69,
          “U” : 70,
          “V” : 71,
          “W” : 72,
          “X” : 73,
          “Y” : 74,
          “Z” : 75,
          “~” : 76,
          “|” : 77,
          “/” : 78,
          “,” : 79,
          “.” : 80,
          “>” : 81,
          “<” : 82,
          “{” : 83,
          “}” : 84,
          “[” : 85,
          “]” : 86,
          “;” : 87,
          “:” : 88,
          “_” : 89,
          “\grave{ }” : 90
          }
  let key=
  9)~|WrMIJx)$unDEk0C5s!Xm{G;H1SjP$v5}zlANMp/rh=olX2[a2$WES4Es0wmmEB
  BK<6h4u0|oOqu+BOS(QtW$s83b/X:Rt\grave{ }ryn0aC[R19M-
  z#$gIsO!,R=Br_Of9hdPzq7H=*TS$$dK77Fa(wn!%z%Lk\grave{ };A,013N<_xXa2R<Y5;Wx|\grave{ }L
  so@a+X7JBn79:9FhuH)ifiqTKO:i%QzqbI&oPs@9<<Mmi{&98mkd0G_CZ{vs=|xg0I_{—}
  <YmL_Qd,#lXjjEC8JuZ]WQlTL6cUh(VDyrgP=H$+:p@kc/bE3X=|Ek0Z}0};6)=f22GL
  OdujS|-i1d4\grave{ }UNj!G_Dc56gh!WcLp,k=h5)RG=~$WFgNcL4j?Yka/:jI)K@xy2=SWy-
  3=75X}bn}YjygtImfTzSs~4k/(u*Wu4--
  u[ ]BVavxtW)rQl9VVWfdJn.i?HTaFpp*{m[oK4@]ZkK0(UM}E5po~5[4UEpei>0N:pES
  i;X\grave{ }U|F2Nj(8(-E}7dc-2Ix$E~N=lG{ }&WgC/az$V$5g>)Y@j]Q6@3-
  K5t]N|M8&A_)t){{[?eJrj~rH~Ie4~|F/?7|sX.:X8]c(41yl@<zP?*GnfT!e%9O1~=#+8-
  M#e]Bxw:)F#|2rCi_Jt*i*b2dk)*sr)?~TA:pclq|w*uZdEvJ/-
  _x5/Orb}5eSB1/AedE?PC|:FTC097bj9:dHoxtdypc;$mC~#wsovxGbnMnpp)|xbMkt9ZRJ
  5uP1{mLgbQB2+6Xtw2HcVeK),Fr]uiKOd+XseLU&\grave{ }Ql&s!F/N2sCKl>Td1F9{o-
  {&yboUp*-
  <0iv/5Y[jlWv&/[&?0/c&nrOWkp!uC6.[T[Ih7Vby&Q3ZM$u|R/$_dH6r>B<J7AuOpvwl
  F>{IZLqwVK0\grave{ }s<-/G8JbS]iplXG_S]PxM1!8iP@Sx.S=kSo>XTCYs4-
  vAdH;coyHSg&9XDpUki=[WJ+V0au_RA;0B{B@ra)eh#Bm-
  kWw=Q\grave{ }Hl3(#iHVfo{r)~=qr}neV*/Q1Li93ZkLsKI%BFX-u7H*)*yp7{m5K,|m-
  Jg{{r[@fm<F<,%$!P)CiFbu>)lYWIq#xZ5R?duuMlXO]MD94L9tg:k$:)-
  %VWN>n!s5Y$aGS0bN9YDA]V#/8/zLe5st}*EB3:,OUyzl8VV:nPO@-
  RO3Cm?7TZW3rI.LKxY7@_oJ.>~-
  dKo/ldEis[;=xvsE/r{4ER,H<y3B@L#Nl$re,,4pwr)>]r?4-
  Ee{ya0tuf>mJ.}J4vYH5ugm2s*ObV>=;p}Hp7.qSWS</y!l~AYi;5I2NiP2=VMvJo/0<hp
  5=>SN]r!v[l\grave{ }u-=w$YVvTCU3TD6r5<X5=KK82a6f2{PD3#:e6F:12q<O(NItaAfX[}i-
  8zc-f7g.@O(bE&YLNT_C2;fM4*4s%r8xNQz{9r41>5e:!07#69-
  <m!P*&4d_NjyK8+7G7!k5NZ}LN3](VqA?G*VaqDf(*KMs]3j5gx-
  a5)!/D&:YzhZiL?{F9rL##j22w,iBru.eBZ:f4hy>!;,/\grave{ }Ea\grave{ }6:)0Vs}]l:BAwr,P@3\grave{ }0Ia]0qcgQ
  +ufidZuEN/cCT,zGS\grave{ }A0W$O!fM2|dXJ<@hW7I5&wf2JDjm~~l,5MGhy2$?/79QH@X
  4TZ>h1<.1deM9\grave{ }l@pf3;5lonbVle}Xi]z0Pa4A{?0-
  1_Am>e6{&V,m>Ofl%h/D8;GJ|5.P|q\grave{ })_~E:L&%e=(MyT1Fi.Jvj/EaQ[f<M;v$k?ZG&jN
  XKH>&a03x5uP:)\grave{ }&#k>T08B5J;u<.dn!e[pC!<_Hcl4ZlgXceD1%@KQQ0u54.SbM8Rp
  QpAz?%OP5{El!frR<jvLZM_[z))[N43]AoMp}kL?i,z7Bqs6;J0,dQ&U}]~zfHYax_2pPL
  :N>tgwmyZ,,2+1]H]RNaRAsFLQk8fBsg-
  ys;|})hja8@,Z(tL74V,=o%W(7s5D:yjf~9@K3ToPS!VP,A;C@D.VA|ffaY5K&lprt;@B9t
  +aI*X:Im76[4Sv!0&#$$sf4>REa2~k{!~-[L-
  tWolrUH)P$h>TyDGTwXsUd<7ZB[L7qTk**i<|cS9)vXixN\grave{ }*4K?wG
    let message = [0010011, 11110000, 1100111,001]
    get 0010011
    let pure position:[ 39,7,1]
    get offset: key[0] = “9” = 9
    let offset position [48,7,1]
    get 11110000
    let pure position: [167,8,2]
    get offset: key[1] = “)” = 46
    let offset position [213,8,2]
    get 1100111
    let pure position: [85,7,1]
    get offset: key[2] = “~” =76
    let offset position: [161,7,1]
    get 001
    let pure position: [0,3,2]
    get offset: key[3] = “|” = 77
    let offset position: [77,3,2]
    final encoded: [48,7,1,213,8,2,161,7,1,161,7,1]
    grouping for 8bit [[48,7,1],[213,8,2], [161,7,1],[77,3,2]]
    get [48,7,1]
    minus offset key[0] = “9” = 9
    pure position = [ 39,7,1]
    byte = 0010011
    get [213,8,2]
    minus offset: key[1] = “)” = 46
    pure position [167,8,2]
    byte = 11110000
    get [161,7,1]
    minus offset: key[2] = “~” =76
    pure position [85,7,1]
    byte = 1100111
    get [77,3,2]
    minus offset: key[3] = “|” = 77
    pure position = [0,3,2]
    byte = 001
    message = [0010011, 11110000, 1100111, 001]
```

The above-described embodiments are intended to be examples of the present disclosure and alterations and modifications may be effected thereto, by those of skill in the art, without departing from the scope of the invention, which is defined solely by the claims appended hereto.

What is claimed is:

1. A method of generating an index and a codex made of a base of N binary digits, the index being an ordered list of all combinations used as a reference for generation of the codex,
wherein the codex comprises one or more layers, each of the one or more layers comprising a randomly ordered list of all combinations of the N binary digits, created using an initiator key and a genesis key; and
the codex is created deterministically using the initiator key and the genesis key to generate said randomly ordered list of all combinations of the N binary digits, each of the initiator key and the genesis key obtained from corresponding random numbers exchanged by each of a set of two or more users for establishing a communication channel.

2. The method of claim 1, wherein N is one of 8, 16, 32, and 64.

3. The method of claim 1, wherein any number of the codex can be generated each having a unique namespace, using the base and a hash function.

4. The method of claim 3, wherein the hash function is MD5.

5. The method of claim 1, wherein the codex comprises of at least of two layers and wherein each layer comprises a different set of randomized combinations.

6. The method of claim 5, wherein said each layer contains 2^{N} combinations of the N binary digits.

7. A method of generating a symmetric encryption key for handshake between a first user and a second user, the method comprising:
at a random number generator (RNG):
i) receiving, at the RNG, requests of digits from the first and second users;
ii) generating a first and second list of numbers at the RNG;
iii) parsing the first and second lists of numbers using a reference table containing symbols associated with the numbers; and
iv) sending a first and second symbol lists to the first and second users respectively;
wherein the symbol lists are combined to create the symmetric encryption key to be sent as a channel creation request or acceptance.

8. The method of claim 7 wherein the symmetric encryption key comprises 2048 symbols.

9. The method of claim 7 wherein the reference table comprises 90 symbols selected from the group consisting of majuscule letters, minuscule letters, special characters, and numbers.

10. The method of claim 7 wherein the reference table excludes quotation marks for easier usage.

11. The method of claim 10, wherein the quotation marks are one of single quotation marks and double quotation marks.

12. A method of encryption of data, using a mutating encryption key and a codex, the method comprising:
i) matching bytes of the data to the codex to obtain corresponding position and byte length;
ii) creating an offset using a value of the encryption key in a pre-mutation state;
iii) keeping a temporary record of the first N bytes of pre-encrypted data as an entropy list;
iv) encrypting the data by adding the offset to said corresponding position to create a positional map of the data in the codex;
v) modifying the encryption key value using each of the first N bytes to create the mutated key value for a post-mutation state for the encryption key; and
vi) saving the mutated key value as the current encryption key.

13. The method of claim 12, wherein said modifying the encryption key ensure unique reshuffling of the codex using incoming bytes.

14. The method of claim 13, wherein valid modification of the encryption key to the post-mutation state requires knowledge of each of the first N bytes and their order.

15. The method of claim 13, wherein said modifying the encryption key value comprises modulo M addition of each of the first N bytes to each digit of the encryption key, where the value of each digit of the key is 0 to M−1.

16. The method of claim 12, further comprising repeating steps 12.i) to 12.v) wherein each mutation of the encryption key depends on a previous value of the encryption key.

17. The method of claim 12, wherein the encryption key value in the pre-mutation state is different from encryption key value in the post-mutation state.

18. The method of claim 12, wherein key mutation is accomplished using pseudo-random numbers.

19. The method of claim 12, wherein the codex comprises a plurality of layers each comprising a randomly ordered list of all combinations of X binary digits, the method further comprising switching to a different layer from a current layer after said modifying the encryption key value.

20. The method of claim 15, wherein M=90.
